(19) United States
(12) Patent Application Publication
(10) Pub. No.: US 2016/0091613 A1
(43) Pub. Date: Mar. 31, 2016

(54) SEMICONDUCTOR RADIATION DETECTOR WITH LOWERED BACKGROUND NOISE LEVEL

(71) Applicant: FENNO-AURUM OY, Espoo (FI)

(72) Inventor: Heikki Johannes SIPILA, Espoo (FI)

(21) Appl. No.: 14/889,210

(22) PCT Filed: May 6, 2013
(86) PCT No.: PCT/FI2013/050491

§ 371 Date: Nov. 5, 2015

(51) Int. Cl. G01T 1/16; G01T 1/24; G01N 23/223

(52) U.S. Cl. CPC G01T 1/1603; G01N 23/223; G01T 1/24

(57) ABSTRACT

A semiconductor radiation detector includes a solid-state X-ray photon detector having a radiation entry side and a back side, and an electron detector adjacent to the radiation entry side of the X-ray photon detector.

### TECHNICAL FIELD

The invention relates in general to semiconductor radiation detectors. Especially the invention is related to detectors that are used to detect fluorescent X-rays from materials the concentrations of which in the measured sample are small.

### BACKGROUND OF THE INVENTION

X-ray fluorescence, or XRF for short, is a well-known and widely used method for analyzing the material constitution of samples. For example in mining industry it is of crucial importance to be able to measure, what constituents are found in the sample and in which concentrations. In looking for relatively precious materials like gold it is desirable to detect and measure even relatively small concentrations in a reliable and accurate manner.

FIG. 1 illustrates schematically an XRF measurement along a conveyor 101. The sample consists of a flow of material 102 that moves constantly by a measurement apparatus. An X-ray source 103 irradiates the sample with incident X-rays, causing constituents of the sample to emit fluorescent X-rays at their characteristic wavelengths. A detector 104 receives the fluorescent X-rays and produces a signal indicative of the energy spectrum (i.e. relative intensity as a function of X-ray photon energy) of the fluorescent radiation. Analyzer electronics 105 are used to derive the concentrations of various constituents in the sample.

The detector 104 is typically a semiconductor radiation detector, in which the most important mechanism of interaction between the incoming X-ray photon and the detector material is the photoelectric effect. The absorption of an X-ray photon in the semiconductor material creates free charge carriers, the number of which is proportional to the original energy of the incoming photon. An electric field drives the created free charge carriers to electrodes in the detector. Measuring the current pulse caused by the charge carriers gives an indication of how energetic the photon was.

A problem in the measurement is the low-energy background, which is illustrated in FIG. 2 and FIGS. 3a to 3c. FIG. 2 illustrates how the output of a multichannel analyzer in the analyzer electronic 105 could look like. FIGS. 3a to 3c illustrate how the multichannel analyzer output can be considered as a superposition of various components: photons of the incident radiation that underwent Compton scattering and thus appear at an energy that is lower than the incident energy by the Compton shift (FIG. 3a), characteristics fluorescent peaks of sample materials (FIG. 3b), and background (FIG. 3c). The last-mentioned is commonly referred to as the low-energy background or background noise, because it forms an essentially continuous floor level between zero and the incident energy, and does not give any useful information. It becomes a nuisance especially if the concentrations of some interesting materials in the sample are low, because their fluorescent peaks may drown in the low-energy background. Accuracy of the measurement could be improved if the general level of low-energy background could be lowered.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

A major source of low-energy background is constituted by radiation-induced charge carriers that fail to make it to the collection electrode(s). Especially close to the surface of a semiconductor radiation detector some electrons escape from the detector material and become attenuated somewhere in the surroundings. According to an aspect of the invention an electron detector is provided for detecting such runaway electrons. If a coincidence is found between detection events in the radiation detector and the electron detector, it is deduced that some of the radiation-induced electrons could not be measured, so the detection event in the radiation detector is discarded.

A semiconductor radiation detector according to an aspect of the invention comprises a solid-state X-ray photon detector having a radiation entry side and a back side, and an electron detector adjacent to the radiation entry side of said X-ray photon detector.

A radiation detector appliance according to an aspect of the invention comprises at least one semiconductor radiation detector of the kind described above.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF DRAWINGS

FIG. 1 illustrates the use of XRF in the measurement of a sample on a conveyor,

FIG. 2 illustrates an energy spectrum,

FIGS. 3a to 3c illustrate the appearance of various components in an energy spectrum,

FIG. 4 illustrates the principle of having an electron detector in front of a radiation detector,

FIG. 5 illustrates the use of a mesh-formed electron detector,

FIG. 6 illustrates the use of a ring-formed electron detector,

FIG. 7 illustrates the use of an electron accelerating electrode, and

FIG. 8 illustrates an X-ray fluorescence analyzer.

### DETAILED DESCRIPTION OF EMBODIMENTS OF THE INVENTION

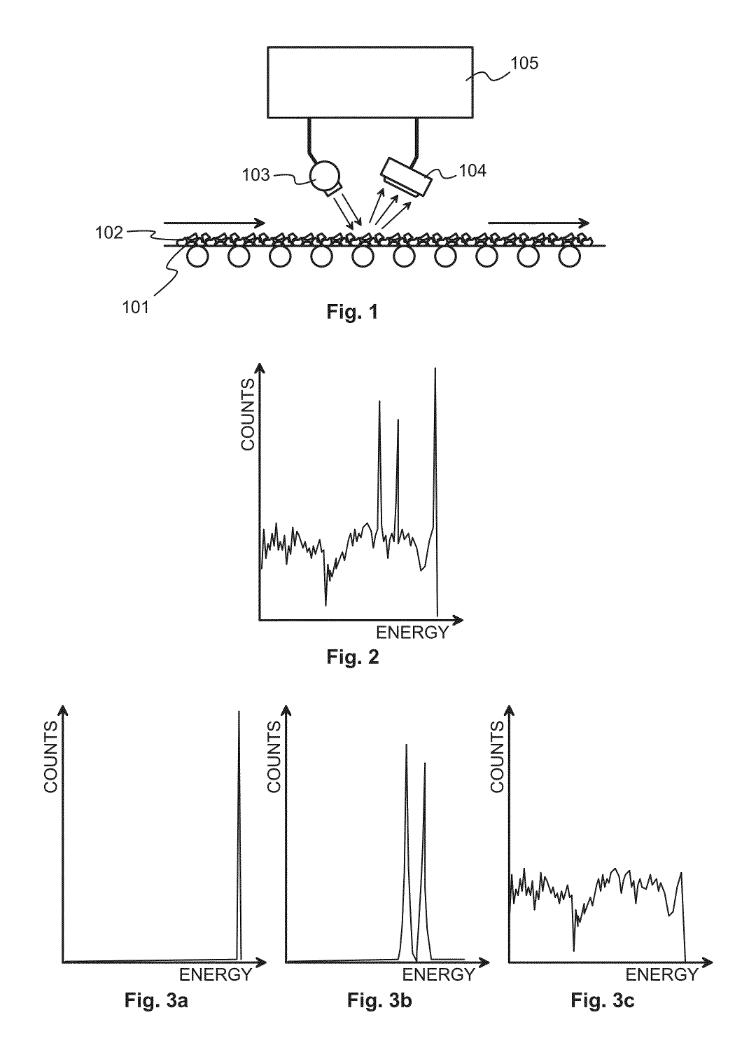

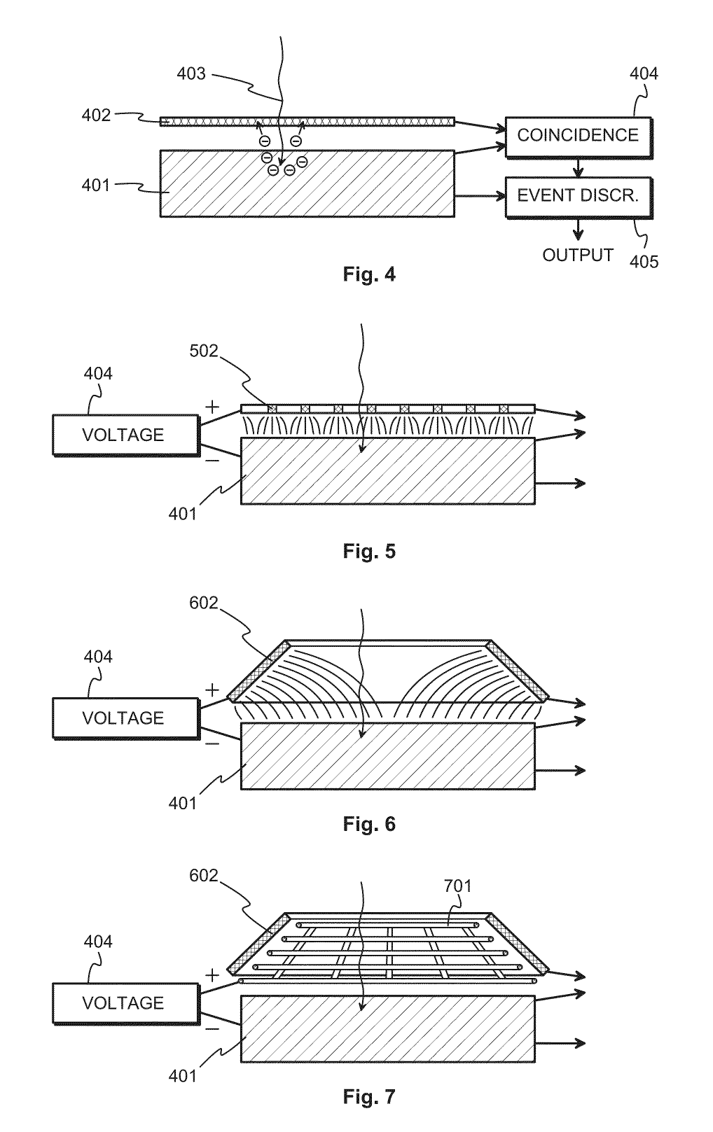

As illustrated in FIG. 4, a semiconductor radiation detector according to an embodiment of the invention comprises a solid-state X-ray photon detector 401 and an electron detector 402. The solid-state X-ray photon detector 401 has a radiation entry side, which is towards the top of the page in FIG. 1, and a back side, which is the opposite side. The electron detector 402 is located adjacent to the radiation entry side of the solid-state X-ray photon detector 401.

An X-ray photon 403, which we assume to have originated in a sample that was irradiated with incident X-rays for an XRF measurement, enters the semiconductor radiation detector from the radiation entry side. The electron detector 402 has a structure that—and/or is made of a material that—makes it highly improbable that the X-ray photon 403 would interact in the electron detector 402. Instead, it passes right through to the solid-state X-ray photon detector 401, where it interacts with the detector material through the photoelectric effect. In other words, the energy of the incoming X-ray photon 403 transforms into energy of free charge carriers, of which electrons are of interest here.

The operating principle of the solid-state X-ray photon detector 401 would require that all created photoelectrons remained within the bulk of its material, but in this example we assume that they do not. In particular if a significant portion of the free charge carriers were created near the surface of the solid-state X-ray photon detector 401, some of them may be energetic enough to escape into the surrounding free space. As a result the measurement of the current pulse that will be created when the photoelectrons are collected to collection electrodes (not separately shown) will not reveal the true energy of the X-ray photon 403. Since the portion of escaped electrons may be anything between 0 and 100% of the originally created photoelectrons, the incompletely collected cloud of photoelectrons will give rise to a completely useless random count that eventually will constitute a part of the low-energy background.

FIG. 4 shows how the radiation detector appliance, a part of which the semiconductor radiation detector is, comprises a coincidence detector 404 that is configured to provide an indication of simultaneous detection events in both the solid-state X-ray photon detector 401 and the electron detector 402. The idea is that since photoelectrons interact much more readily with the electron detector 402 than X-ray photons do, at least some of the escaped photoelectrons could be detected with the electron detector 402. The distances involved are small enough in relation to the expected velocities of photoelectrons propagating through empty space, so the detection events that are related to the same incoming X-ray photon take place essentially simultaneously in both detectors, which is noticed by the coincidence detector 404.

The radiation detector appliance further comprises an event discriminator 405 that is configured to discard from a measurement a detection event in the solid-state X-ray photon detector 401 as a response to the coincidence detector 404 indicating a simultaneous detection event in the electron detector 402. Only those detection events in the solid-state X-ray photon detector 401 make it to the output after the event discriminator 405 for which there was no simultaneous detection event in the electron detector 402.

A semiconductor radiation detector constructed according to the principle illustrated in FIG. 4 is most useful for detecting X-rays that are energetic enough so that a large majority of them can be assumed to pass through the electron detector 402 without interactions. Naturally the electron detector 402 must also be constructed so that it is effective in detecting escaped photoelectrons but relatively transparent to incoming X-rays. As an example for a measurement aimed at detecting fluorescent X-rays of gold, the electron detector 402 may comprise a layer of diamond, silicon, or silicon carbide that has a thickness between 10 and 50 micrometers. The fluorescent radiation from pure gold comes primarily at 11.44 keV (L-beta-one) and 9.71 keV (L-alpha-one), with some additional contribution at 13.38 keV (L-gamma-one) and 8.49 keV (L-L). At these energies the interaction cross-section of the incoming X-ray photon with a 10 to 50 micrometer thick diamond, silicon, or silicon carbide layer is so small that the diamond, silicon, or silicon carbide layer can be made to cover the entry of incoming radiation to the solid-state X-ray photon detector as a continuous layer.

In principle the electron detector 402 could be located very close or even immediately adjacent to the surface of the solid-state X-ray photon detector 401. However, since detecting escaped photoelectrons is actually only the second best thing to do to avoid low-energy background (the best being to ensure that they did not originally escape at all) it is advantageous to take some measures to discourage the electrons from leaving the atomic lattice of the solid-state X-ray photon detector 401. A boundary between a solid material and vacuum constitutes such a measure, so it is recommendable to have an empty gap between the electron detector 402 and the surface of the solid-state X-ray photon detector 401. The gap should be at vacuum so that photoelectrons flying out are not scattered and slowed down before they reach the electron detector. Semiconductor radiation detectors are frequently enclosed in vacuum anyway to help maintain their cooled temperature, so ensuring a vacuum in said gap may require little or no other changes to the structure. The dimension of said gap in the direction perpendicular to the surface of the solid-state X-ray photon detector 401 may be for example between 100 and 500 micrometers.

If the aim is to measure softer X-rays, which might significantly interact or even become completely absorbed in the electron detector, it is possible to make the electron detector define an opening for incoming radiation to pass through to the solid-state X-ray photon detector. Various structural alternatives exist: for example the electron detector may be made to have the form of a mesh or a ring. FIG. 5 illustrates a semiconductor radiation detector in which the electron detector 502 is a mesh, and FIG. 6 illustrates a semiconductor radiation detector in which the electron detector 602 is a ring.

A photoelectron that escaped from the solid-state X-ray photon detector propagates linearly, so a discontinuous electron detector could run a risk of not noticing photoelectrons if they fly through the opening(s). That risk can be made smaller by coupling a voltage between the solid-state X-ray photon detector and the electron detector, and selecting the polarity of the voltage so that it drives free-flying electrons towards the electron detector. In the schematic illustrations of FIGS. 5 and 6 the radiation detector appliance comprises a voltage output 503 that is coupled to the solid-state X-ray photon detector and the electron detector for creating an electric field accelerating electrons towards the electron detector. Some field lines of the electric field are schematically shown in FIGS. 5 and 6. Having a gap between the solid-state X-ray photon detector and the electron detector is advantageous also here, because it decreases the risk of the voltage discharging through an electric breakdown between the two detectors.

The electric field can also be created with a separate accelerating voltage electrode. Such a solution is schematically shown in FIG. 7, where the accelerating voltage electrode appears in the form of a sparse grid 701 located between the solid-state X-ray photon detector 401 and the electron detector 602. Electric field lines are not shown in FIG. 7 in order to maintain graphical clarity.

The bulk layer of the solid-state X-ray photon detector 401 may be for example silicon or germanium or other semiconductor material. The thickness of the bulk layer is advantageously selected large enough so that it would be highly improbable that any X-ray photon of interest would pass completely through the bulk layer. This way it can be ensured that the phenomenon of escaping photoelectrons does not take place at the back side of the solid-state X-ray photon detector 401. In most applications it is sufficient to require that the bulk layer of semiconductor material is thicker than 300 micrometres, but it can be as thick as 15 centimetres.

If the bulk layer cannot be made very thick and consequently there is a risk that some X-ray photons could interact so close to the back side surface of the solid-state X-ray photon detector 401, the semiconductor radiation detector may be made to comprise another electron detector on the back side of the solid-state X-ray photon detector. In such a case the coincidence detector should be configured to give an indication if a detection event takes place simultaneously in the solid-state X-ray photon detector and at least one of the electron detectors.

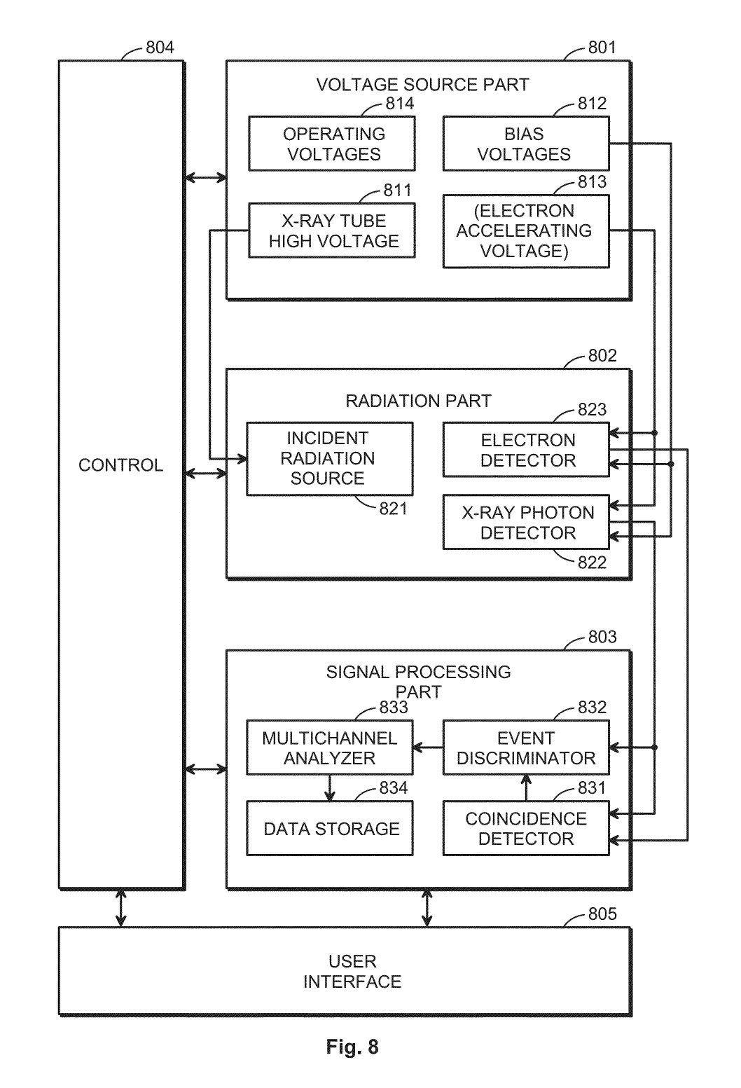

FIG. 8 illustrates schematically an X-ray fluorescence analyzer that can be used to detect the presence, both qualitatively and quantitatively, of various substances in a sample; for example to detect the presence of gold in ore or in concentrate. Main functional blocks of the analyzer are the voltage source part 801, the radiation part 802, and the signal processing part 803. A control block 804 is configured to control the operation of all functional blocks in the analyzer, and a user interface 805 is provided for allowing a user to enter commands as well as to examine measurement results and to follow the operation of the analyzer.

In the voltage source part 801 an X-ray tube high voltage block 811 is configured to produce the high voltage that is needed in an X-ray tube to generate incident radiation. A bias voltages block 812 is configured to produce the bias voltages that are needed in the detectors to make them work properly. A separate electron accelerating voltage block 813 may be provided, if a separately generated electric field is used to accelerate escaped photoelectrons towards the electron detector. An operating voltages block 814 is configured to produce the various other operating voltages needed in the analyzer.

The radiation part 802 comprises an incident radiation source 821, which is typically an X-ray tube. Additionally the radiation part 802 comprises a solid-state X-ray photon detector 822 and an electron detector 823, which constitute a semiconductor radiation detector according to an embodiment of the invention.

A separate electron accelerating voltage may be discarded with if the electric potential levels that constitute the bias voltages generated in block 812 have been selected so that an electron-accelerating potential difference already exists between the adjacent surfaces of the solid-state X-ray photon detector 822 and the electron detector 823 as a result of their appropriate biasing.

The signal processing part 803 comprises a coincidence detector 831 that is configured to provide an indication of simultaneous detection events in both the solid-state X-ray photon detector 822 and the electron detector 823. The signal processing part 803 also comprises an event discriminator 832 configured to discard from a measurement a detection event in the solid-state X-ray photon detector 822 as a response to the coincidence detector 831 indicating a simultaneous detection event in the electron detector 823. The output of the event discriminator 832 is coupled to a multichannel analyzer 833 so that qualifying events can be collected and used to compose an energy spectrum of the received X-rays. A data storage 834 is provided for storing the measured spectra.

The invention can be applied irrespective of whether the radiation detector appliance operates in continuous mode or in a discontinuous fashion, like in a pulsed mode.

1. A semiconductor radiation detector, comprising:
a solid-state X-ray photon detector having a radiation entry side and a back side, and
an electron detector adjacent to the radiation entry side of said X-ray photon detector.

2. A semiconductor radiation detector according to claim 1, wherein the electron detector comprises a layer of diamond, silicon, or silicon carbide that has a thickness between 10 and 50 micrometers.

3. A semiconductor radiation detector according to claim 1, wherein the diamond, silicon, or silicon carbide layer covers the entry of incoming radiation to the solid-state X-ray photon detector as a continuous layer.

4. A semiconductor radiation detector according to claim 1, wherein the electron detector defines an opening for incoming radiation to pass through to the solid-state X-ray photon detector.

5. A semiconductor radiation detector according to claim 4, wherein the electron detector has the form of a mesh or a ring.

6. A semiconductor radiation detector according to claim 1, wherein the shortest distance between the solid-state X-ray photon detector and the electron detector is between 100 and 500 micrometers.

7. A semiconductor radiation detector according to claim 1, wherein the solid-state X-ray photon detector comprises a bulk layer of semiconductor material that is thicker than 300 micrometers.

8. A semiconductor radiation detector according to claim 1, comprising another electron detector on the back side of the solid-state X-ray photon detector.

9. A radiation detector appliance, comprising a semiconductor radiation detector according to claim 1.

10. A radiation detector appliance according to claim 9, comprising a coincidence detector configured to provide an indication of simultaneous detection events in both the solid-state X-ray photon detector and the electron detector.

11. A radiation detector appliance according to claim 10, comprising an event discriminator configured to discard from a measurement a detection event in the solid-state X-ray photon detector as a response to the coincidence detector indicating a simultaneous detection event in the electron detector.

12. A radiation detector appliance according to claim 9, comprising a voltage output coupled to the solid-state X-ray photon detector and the electron detector for creating an electric field accelerating electrons towards the electron detector.

13. A semiconductor radiation detector according to claim 2, wherein the diamond, silicon, or silicon carbide layer covers the entry of incoming radiation to the solid-state X-ray photon detector as a continuous layer.

14. A semiconductor radiation detector according to claim 2, wherein the electron detector defines an opening for incoming radiation to pass through to the solid-state X-ray photon detector.

15. A semiconductor radiation detector according to claim 14, wherein the electron detector has the form of a mesh or a ring.

16. A semiconductor radiation detector according to claim 2, wherein the shortest distance between the solid-state X-ray photon detector and the electron detector is between 100 and 500 micrometers.

17. A semiconductor radiation detector according to claim 2, wherein the solid-state X-ray photon detector comprises a bulk layer of semiconductor material that is thicker than 300 micrometers.

18. A radiation detector appliance according to claim 10, comprising a voltage output coupled to the solid-state X-ray photon detector and the electron detector for creating an electric field accelerating electrons towards the electron detector.

19. A radiation detector appliance according to claim 11, comprising a voltage output coupled to the solid-state X-ray photon detector and the electron detector for creating an electric field accelerating electrons towards the electron detector.
